(19) United States
(12) Patent Application Publication
(10) Pub. No.: US 2002/0073584 A1
(43) Pub. Date: Jun. 20, 2002

(54) Apparatus and method for improved advertising exposure

(76) Inventor: Justin Huddy, brick, NJ (US)

Correspondence Address: Thomason, Moser & Patterson, LLP, Attorneys at Law, Suite 100, 595 Shrewsbury Avenue, Shrewsbury, NJ, 07702, US

(21) Appl. No.: 09/900,566

(22) Filed: Jul. 6, 2001

Related U.S. Application Data
(60) Provisional application No. 60/216,791, filed on Jul. 7, 2000.

(51) Int. Cl. G09F 3/00

(52) U.S. Cl. 40/312; 40/313

(57) ABSTRACT

An apparatus for improved advertising comprising a container for the temporary storage of goods having a lid and an advertisement disposed upon said lid, wherein said advertisement is not related to the goods stored in the container. Additionally and further to the invention, the container may further have a second advertisement disposed upon an inside surface of said lid or other neighboring surfaces of which the lid is constructed.

This application claims the benefit of U.S. Provisional Application No. 60/216,791 filed on Jul. 7, 2000, which is herein incorporated by reference.

### BACKGROUND OF THE DISCLOSURE

The American business model is derived from laissez-faire capitalism. Prosperity of a particular company depends on development of sufficient revenue to achieve a profit. As such, it is important that companies continue to develop new methods of attracting potential customers along with the goods/services the company provides. For example, a manufacturer must find ways of making their goods more desirable than a competitors goods in order to generate the desired revenue. An entire industry, i.e., the advertising industry, has flourished as the need to “get the message to the people” has increased.

Typical examples of the techniques used by the advertising industry include, but are not limited to, billboards, radio and television commercials, printed advertisements in publications pertaining to a particular interest (i.e., a manufacturer of a new golf club placing an advertisement in a magazine pertaining to the sport of golf) and the like. While each of these techniques are effective to some extent, they have their disadvantages. For example, a typical radio or television commercial is between approximately 30 secs. and one minute in length, yet can cost anywhere from a few thousand to a half a million dollars depending on the anticipated number of listeners/viewers of said commercial. Such constraints limit the ability of the company to effectively convey their message if not professionally prepared (at yet an additional cost charged by an advertising agency). A billboard or magazine advertisement suffers from the same drawback (professional preparation fees) and is focused on as a point of interest by a potential customer for much less time (perhaps only one to a few seconds).

Therefore, a need exists in the art for an apparatus and method of conveying advertisements that holds the attention or remains in the view of a potential customer for a substantial amount of time, yet is not prohibitively costly.

### SUMMARY OF THE INVENTION

The disadvantages of the prior art are overcome by the present invention of an apparatus for improved advertising comprising a container for the temporary storage of goods having a lid and an advertisement disposed upon said lid, wherein said advertisement is not related to the goods stored in the container. Additionally and further to the invention, the container may further have a second advertisement disposed upon an inside surface of said lid.

### BRIEF DESCRIPTION OF THE DRAWINGS

The teachings of the present invention can be readily understood by considering the following detailed description in conjunction with the accompanying drawings, in which:

FIG. 1 depicts a perspective view of an advertising apparatus (food container) in accordance with the subject invention; and

FIG. 2 depicts a perspective, internal view of the subject apparatus as an alternate and/or enhanced advertising means.

To facilitate understanding, identical reference numerals have been used, where possible, to designate identical elements that are common to the figures.

### DETAILED DESCRIPTION

After considering the following description, those skilled in the art will clearly realize that the teachings of the subject invention can be readily utilized in the advertising industry as a means to increase the time an advertisement is exposed to a potential customer. Similar in theory to the billboards discussed above, but as of yet unexploited as a viable medium for advertising is the fast food container. A wide variety of fast food franchise restaurants as well as independently owned and operated locations all use some type of “take-out” container. These “take-out” containers protect the food therewithin while allowing for easy transport of the food from the restaurant to another location. However, such containers are either unmarked (i.e., Chinese food pint and quart white boxes) or generically and food-industry-related marked (i.e., a pizza box that has a pizza-related graphic or the restaurant name or similar information). Such blank or underutilized space amounts to lost advertising.

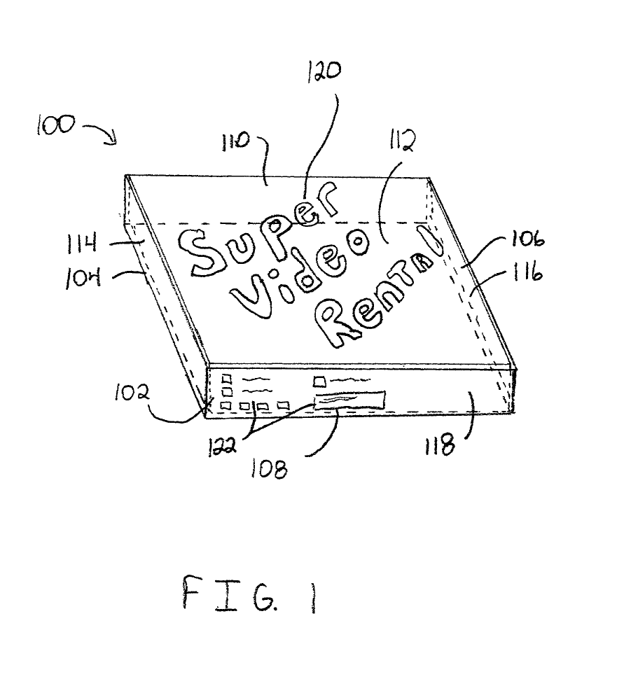

FIG. 1 depicts a container 100 comprising an advertisement 120 thereupon. The container 100 comprises a bottom 102, a left side 104, a right side 106, a front side 108 and a back side 110 appropriately oriented and connected to one another. The back side 110 transitions into a top or lid 112 that closes over the container 100 to seal and protect contents therein. The lid 112 is further provided with a left side flap 114, a right side flap 116 and a front side flap 118 appropriately oriented and connected to the lid 112. Each of said flaps 114, 116 and 118 tuck into the container when the lid 112 is closed to further protect and seal the contents. The front side 108 of the container 100 may optionally be provided with markings or additional information 122 regarding the contents of the container 100. In one preferred embodiment of the subject invention, the container 100 is a box used to hold and transport pizza from a source (restaurant, pizza shop or the like) to a delivery destination (house, hotel room or the like). The specific dimensions of the box are not provided in this disclosure as it will be known to one skilled in the art of pizza making and delivery that such box (container 100) must be large enough to accommodate its contents (i.e., a 16″ diameter pizza pie) without degrading, destroying or otherwise tainting the contents prior to delivery. Furthermore, although a pizza box is provided as an example and preferred embodiment, this does not limit the invention or its use or method of conveying advertisements to same. That is, the invention incorporates an apparatus and method for improved advertising via a container for storing one type of goods and placing one or more advertisements for goods and/or services unrelated to the stored goods on the container.

AS indicated, the container 100 is provided with at least one advertisement, a first advertisement, 120 disposed upon the lid 112. The first advertisement 120 provides useful information regarding one or more products or otherwise attracts a potential consumer to a particular company's goods/services. The first advertisement is selected to appeal to a consumer of non-food related goods/services and may also share a common market or demographic as the particular food provided in the container 100. Non-food related is defined as anything that is not the food provided in the container 100. For example and as shown in FIG. 1, an advertisement for a local video rental establishment proximate the pizza shop making and selling the pizza is provided. The party that ordered the pizza may also plan on spending the evening at home after dinner watching a movie that can be rented from the local video rental establishment. The depiction of FIG. 1 is for exemplary purposes only and does not limit the invention. Any type of non-food related advertising is acceptable in such a container 100 that is suited for holding food. For example, while a local video rental establishment is shown, that does not preclude any type of other non-food related advertising such as by a regional or national video rental establishment, party planners, wireless communication services, dry cleaners, currently released feature film promoters and the like.

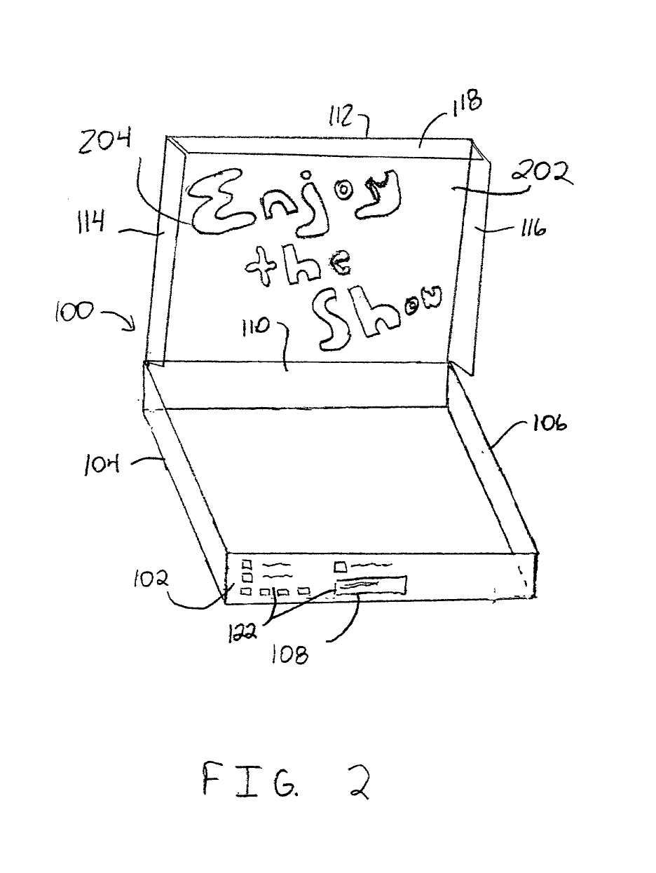

FIG. 2 depicts an alternate and/or additional feature of the subject invention. Specifically, the container 100 is shown with the lid 112 opened to reveal the contents (i.e. a pizza, not shown). Opening the lid effectively blocks at least some portion of the first advertisement 120 on the lid 112; however, it does reveal an inside surface 202 of the lid 112. At least one additional advertisement, a second advertisement, 204 is disposed on the inside surface 202 of the lid 112 thus doubling the amount of available advertising space on the container 100. As discussed with respect to the first advertisement 120, the second advertisement 204 can be any type of non-food related advertising that is acceptable in such a container 100 that is suited for holding food. For example while an advertisement for a local video rental establishment is shown, (actually a two-part advertisement that comprises first advertisement 120 and second advertisement 204) that does not preclude any type of other non-food related advertising. Additionally two-part advertisements are only one example of many possible combinations of advertisements which are known and can be effectively coordinated and displayed on the container to one skilled in the art of advertising. Further still, and in additional embodiments of the invention, a plurality of advertisements are disposed upon any or all of the sides 104, 106, 108 or 110, flaps 114, 116 or 118 or other underutilized surfaces of the container 100. The plurality of advertisements are separate and distinct or continuations (graphically, text or otherwise) of the first and/or second advertisements 120 and 204, respectively.

The benefits of such an invention are easily seen in that the exposure time of the advertisements 120 and/or 204 is substantially increased over those of conventional advertising methods. For example, when carrying the container from the source to its destination, any number of individuals will view the advertisement 120 on the lid 112. Additionally, as food is being dispensed from the open container 100, the advertisement 204 on the inside surface 202 of the lid 112 will be viewed. If the food is dispensed repeatedly, there are multiple viewings of each advertisement until such time that the container 100 is discarded. Conceivably, exposure time is anywhere from ½ hr. to 24 hours.

Although various embodiments which incorporate the teachings of the present invention have been shown and described in detail herein, those skilled in the art can readily devise many other varied embodiments that still incorporate these teachings.

What is claimed is:

1. An apparatus for improved advertising comprising:
a container for the temporary storage of goods, said container further comprising a lid and
an advertisement disposed upon said lid, wherein said advertisement is not related to the goods stored in the container.

2. The apparatus of claim 1 further comprising:
a second advertisement disposed upon an inside surface of said lid.
